(19) United States
(12) Patent Application Publication
(10) Pub. No.: US 2023/0026745 A1
(43) Pub. Date: Jan. 26, 2023

(54) LIFTING, STABILIZING AND PROPELLING ARRANGEMENT FOR VERTICAL TAKE-OFF AND LANDING AIRCRAFT

(71) Applicant: Manuel MUÑOZ SAIZ, Almeria (ES)

(72) Inventor: Manuel MUÑOZ SAIZ, Almeria (ES)

(21) Appl. No.: 17/791,207

(22) PCT Filed: Jan. 12, 2021
(86) PCT No.: PCT/ES2021/000003

§ 371 Date: Jul. 7, 2022

(30) Foreign Application Priority Data
Jan. 13, 2020 (ES) P202000011
Jan. 13, 2020 (ES) U202000027
Jan. 13, 2020 (ES) U202000028

(51) Int. Cl. B64C 9/02; B64D 27/24; B64C 39/02; B64C 13/50; B64C 5/06

(52) U.S. Cl. CPC B64C 9/02; B64D 27/24; B64C 39/024; B64C 13/50; B64C 5/06; B64C 29/0008

(57) ABSTRACT

The lifting, stabilizing and propelling arrangement for vertical take-off and landing aircraft, uses rotating wings, turbines or lift fans, propellers and stabilizers on the trailing edges of the wings and empennages, centrifugal or tangential turbines applied on the sides of the fuselage, on the inlet and outlet edges of the wings, or centrifugal or tangential turbines on the sides of the fuselage and inside the wings, those that carry the fuselage are fixed and produce only lift and those that go in the wings they rotate with them and produce lift during vertical flight and propulsion during horizontal flight, add some horizontal stabilizing fans at the tips of the wings and others for direction in the vertical empennage.

### FIELD OF THE INVENTION

In lifting, stabilization and propulsion systems for manned and unmanned aircraft or drones.

### STATE OF THE ART

Autogyros do not perform vertical take-off, helicopters move at low speed, their rotor is dangerous and current VTOL aircraft are unsafe and make very poor use of the energy of the turbines at low altitude and low speed. The present invention overcomes these drawbacks.

### DESCRIPTION OF THE INVENTION

### Objective of the Invention and Advantages

Achieve vertical take-offs without many automatisms, using turbines or fixed fans.

Use turbines or fans driven by electric motors.

Use turbines or electric fans to generate lift both on take-off and in horizontal flight.

Use electrical power from fuel cells, turboshaft-driven generators, turboprops, reciprocating combustion engines or gas turbines.

Advantages: It is practical, very simple, economical, performs an optimal vertical flight, can be used for transport, drones or UAVs, firefighting, rescue, splashdown and long-range flights.

### Problem to Solve

The drawbacks of current vertical take-off aircraft, which are complex, being forced to lift a lot of weight and consequently have short range.

The lifting, stabilizing and propelling arrangement for vertical take-off and landing aircraft of the invention consists of applying to the fuselages four rotating main wings, or rotating portions thereof, which carry rows of turbines, fans and turbines on their trailing edge. fixed turbofans, apply rows of fixed centrifugal or tangential turbines to the sides of the fuselage, inside the wings and tail fin and apply rows of centrifugal or tangential turbines and some turbofans to the sides of the fuselage and the lower and upper area of the rotating wings, rows of tangential turbines and turbofans that adopt during take-off and landing, by the placement of the wings, vertical or lift and stabilization thrust. In horizontal flight the wings act as lifts and the turbines or fans are placed in such a way that they produce horizontal propulsion with a slight nose-up inclination. The fans, turbines are driven by electric motors, powered by batteries, fuel cells or electric generators driven by gas turbines, the engines and the fans or turbines.

In a variant, it can produce propulsion exclusively with the fans or turbines, in this case using wings with a small surface, which are preferably used to support the fans and turbines.

Corner fans, turbine and turbofans can be used as stabilizers.

Only one pair of wings can be used in that case the tail stabilizer plane carries lifters, stabilizers and propellers.

The number of motors, fans, etc., depends on their size or diameter.

To drive the electric generators of the fans, propellers, etc. can use one or more propulsive or auxiliary turbines, mini-turbines, microturbines and nanoturbines. To avoid repetition in what follows, when mentioning turbines, we will also refer to miniturbines, microturbines and nanoturbines.

Using half of the fans, propellers, etc. turning in one direction and the other half in the opposite direction eliminates the torque that is created.

In horizontal flight, part of the lift can be generated by the wing or ventral surface of the fuselage.

In horizontal flight, stability is obtained by means of the ailerons and elevators and rudders located on the horizontal and vertical fins, it can also be obtained by means of fans. In vertical displacement, horizontal stabilization is obtained by means of three or more electric fans located at the tips of the wings, both empennages horizontal and optionally in the nose area. In the automatic flight system GPS signals, accelerometers, gyroscopes, anemometer, height, variometers, radio altimeters, VORs, ADFs, heading, (heading, height, speed and rate of climb or descent selected), are received or produced in the microprocessor-based automatic flight system. which, processed, give information or indication signals, and control for the fans, ailerons, depth and steering rudders that are applied with electric or hydraulic servo systems. The control can also be done manually, applying variable signals.

Fans used for stabilization and turbines are driven by electric motors, fed with battery, fuel cells, turboshaft-driven generators, turboprops, reciprocating combustion engines, or gas turbines.

The fans used for stabilizing and the electrically driven control fans or propellers are controlled by independent motors and circuits, to guarantee their performance in case of failure. The same fans and electric motors used to produce lift can be used.

The lower part of the fuselage is flat, providing, together with the wings, lift during horizontal flight. The rear wings are placed at different heights to avoid interference with the wake of the front wing and/or the engines.

The electric motors can additionally be fed with super capacitors, during short periods of time, emergencies, etc., which can be reserved exclusively for the initial climb of the take-off and at the end of the descent or landing, in the latter cases the electrical cost is very small, using generators as complementary elements and for greater safety. The electrical generators will reinforce the power applied by the batteries and will charge them during horizontal flight.

In an emergency it can also land like a conventional plane and can splash down by adding floats that can be inflatable.

Optionally, one or more fins at the outlet behind the fans can deflect the airflow with respect to the direction of the duct, allowing the aircraft to ascend and descend horizontally.

It can be adapted to all types of aircraft, Delta wings, biplanes, flying wings and, in general, to all aircraft with large wing or horizontal surfaces.

On the vertical empennage the rudders and fans control the direction.

In cases of using hydrogen for fuel cells, the fuel can be towed in a special tank in the tail of the plane to prevent explosions in the plane.

The propulsion can be performed by electric fans, for drones and short-haul aircraft, or by turbofans once it has risen vertically and until it descends when using a large load or long range.

### BRIEF DESCRIPTION OF THE DRAWINGS

FIG. 1 shows a schematic plan and partially sectioned view of an arrangement of the aircraft of the invention with the wings in vertical flight.

FIG. 2 shows a schematic side plan and partially sectioned view of the aircraft with the wings in horizontal flight.

FIG. 3 shows a schematic side view of the aircraft in horizontal displacement.

FIG. 4 shows a plan and schematic plan view and partially sectioned of an aircraft variant.

FIG. 5 shows a schematic and sectional view of a wing with three tangential or centrifugal turbines of the invention inside.

FIG. 6 shows a schematic plan view of an aircraft variant with tangential or centrifugal turbines in all possible places. Propeller or turboprop propelled.

FIG. 7 shows a schematic and sectional view of a tangential or centrifugal turbine of the invention, in the intrados of a portion of the wing.

FIG. 8 shows a schematic and sectional view of a pair of tangential or centrifugal turbines, one on the intrados and the other on the extrados of a portion of the wing.

FIG. 9 shows a schematic plan and partially sectioned view of an aircraft variant with the wings and centrifugal or tangential turbines in vertical flight.

### MORE DETAILED DESCRIPTION OF AN EMBODIMENT

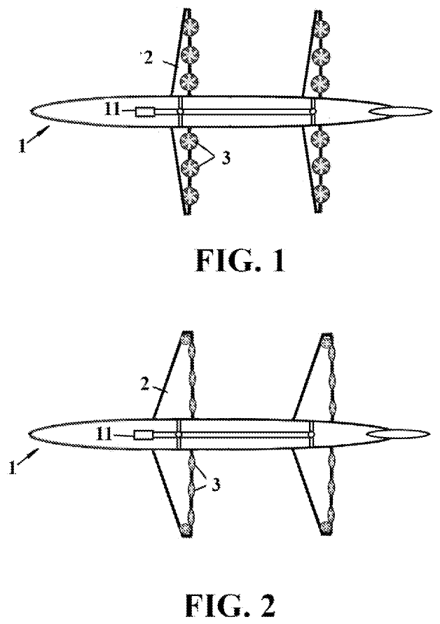

FIG. 1 shows an embodiment of the invention with the aircraft (1), turbines, fans or lifting and propellers (3) at the trailing edges of the rotating wings (2), rotated by the electrical, hydraulic or pneumatic system (11). The wings and turbines are in vertical displacement arrangement.

FIG. 2 shows the aircraft (1), turbines, fans or lifting and propellers (3) at the trailing edges of the rotating wings (2), rotated by the electrical, hydraulic or pneumatic system (11). The wings and turbines are in horizontal displacement or horizontal flight.

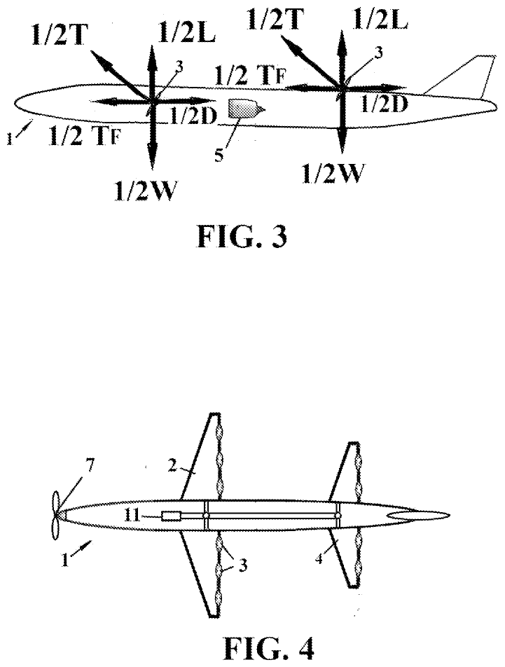

FIG. 3 shows the aircraft (1), with two rows of fans (3) on each side and in horizontal flight. Where 1/2 T is the pull of the front or rear rows of fans or turbines, 1/2 TF the forward pull of the front or rear rows of fans or turbines, 1/2 L half the lift of the aircraft, 1/2 W half its weight and 1/2 D half the aircraft's drag. The rear wings are placed higher to avoid interference with the wake of the front wing and/or engines. It shows the aircraft with the lift arrangement of the invention in a horizontal displacement attitude. The turbofan propeller (5).

FIG. 4 shows the aircraft (1), turbines, fans or lifting and propellers (3) at the trailing edges of the main rotating wings (2) and the smaller rear ones (4) also rotating. It is propelled by the propeller or turboprop (7). The wings and turbines are rotated by the electrical, hydraulic or pneumatic system (11). The wings and turbines are in vertical displacement arrangement.

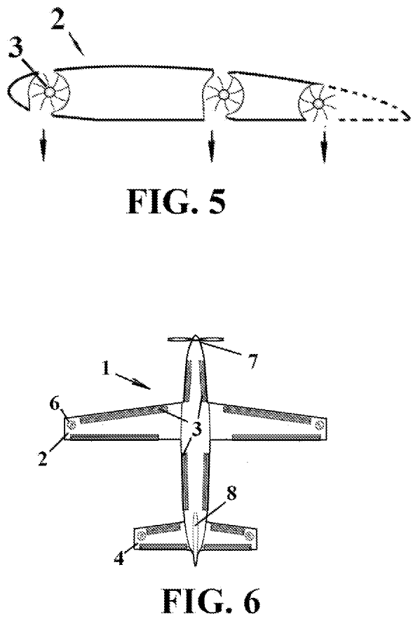

FIG. 5 shows an embodiment with a wing (2) with three tangential or centrifugal turbine runners (3r) that throw the air flow downwards.

FIG. 6 shows the aircraft (1), with two main or larger wings (2) and the two rear or smaller ones (4). They show the centrifugal or tangential turbines (3r). The vertical stabilizer (8) and the stabilizer fans (6). As a propellant it uses the propeller (driven by an engine) or turboprop (7).

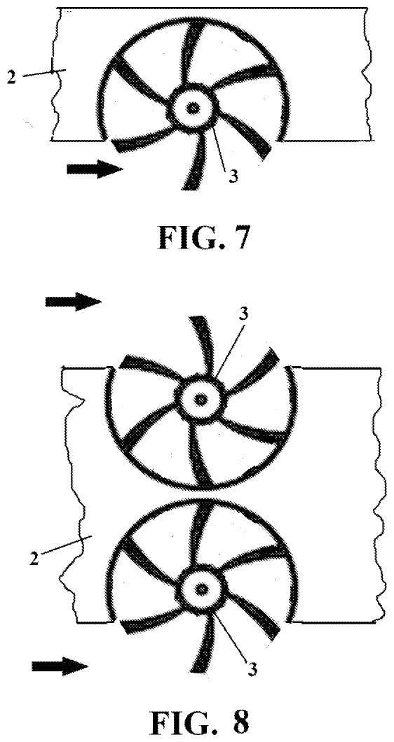

FIG. 7 shows the portion of a wing (2) and the impeller of the tangential or centrifugal turbine (3r) that drives the air flow tangentially.

FIG. 8 shows the portion of a wing (2), with the pair of impellers of the tangential or centrifugal turbines (3) that drive the air flow tangentially through the intrados and the extrados.

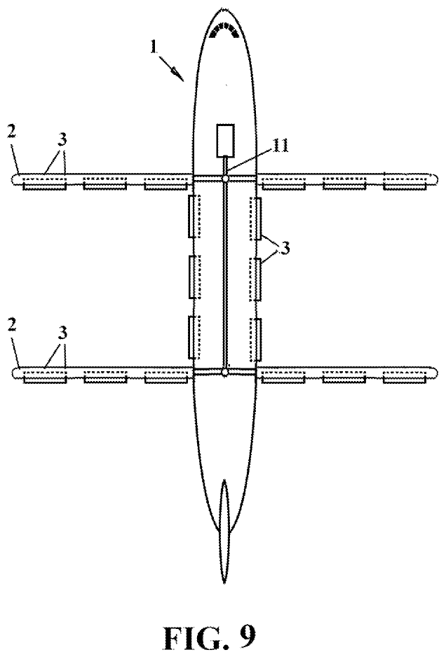

FIG. 9 shows an embodiment with the aircraft (1), with four equal wings (2), the runners of the tangential or centrifugal turbines (3r) on the wings and the side of the fuselage. The wings are rotated with the installation (11) by mechanical, pneumatic, hydraulic or electrical means.

In cases of smaller hindwings, they can be confused with typical horizontal stabilizers.

For very small sizes, drones, etc. stabilizing fans can be used as lifters, even during horizontal flight, in place of standard wings, ailerons, and elevators and rudders.

1. Lifting, stabilizing and propelling arrangement for vertical take-off and landing aircraft, comprising:
A fuselage with four main rotating wings or portions thereof rotating,
Rows of turbines or fans and fixed turbofans applied to the trailing edges, or in portions or sections thereof.
Some rows of fixed tangential or centrifugal turbines applied to the sides of the fuselage, inside the wings or tail fins,
Some rows of fixed tangential centrifugal turbines and turbofans, applied to the sides of the fuselage and the lower and upper area of the wings,
Some lifting systems,
Some stabilization systems and
Some propulsion systems,
which adopt during take-off and landing, due to the positioning of the wings, vertical thrust or lifting and stabilization, and in horizontal flight the wings act as lifters and the turbines or fans are placed in such a way that they produce propulsion with a slight nose-up inclination.

2. Arrangement according to claim 1, wherein the fans, turbines or fans are driven by electric motors, powered by batteries, fuel cells or by electric generators driven by gas turbines, the engines and the fans or turbines.

3. Arrangement according to claim 1, wherein the propulsion occurs exclusively with the fans, turbines or fans, using in this case wings with a small surface, which are preferably used to support the fans and turbines.

4. Arrangement according to claim 1, wherein in vertical displacement the horizontal stabilization is obtained by means of three or more electric fans located at the tip of the wings, both tail fins horizontal and optionally in the nose area.

5. Arrangement according to claim 1, wherein the use of two main wings and two rear ones that are smaller and placed higher than the main ones.

6. Arrangement according to claim 1, wherein propellant miniturbines, microturbines and nanoturbines are used to drive the electrical generators of the turbines, fans or propellers.

7. Arrangement according to claim 1, wherein half of the turbines, fans or propellers rotate in one direction and the other half in the opposite.

8. Arrangement according to claim 1, wherein in horizontal flight stability is obtained by means of the ailerons and elevators and rudders located on the horizontal and vertical fins.

9. Arrangement according to claim 1, wherein stability is optionally obtained in horizontal flight by means of the motors and the fans.

10. Arrangement according to claim 1, wherein the aircraft is controlled manually, acting on the flaps or fans.

11. Arrangement according to claim 1, wherein a pair of electric fans in the vertical empennage control the course.

12. Arrangement according to claim 1, wherein the electrically actuated control fans or propellers are controlled by independent motors and circuits.

13. Arrangement according to claim 1, wherein in automatic flight some gyroscopes detect the change of attitude with respect to the horizontal and to the heading, generating signals that act on the electric motors that activate the horizontal and vertical stabilizing fans, so that it corrects the deviations or unwanted inclinations, a pair of electric fans in the vertical empennage control the course.

14. Arrangement according to claim 1, wherein the lower area of the fuselage is flat, providing, together with the wings, lift during horizontal flight.

15. Arrangement according to claim 1, wherein the electric motors are additionally powered with supercapacitors, during short periods of time and emergencies.

16. Arrangement according to claim 1, wherein the system adapts to all types of aircraft, delta wings, biplanes, flying wings and in general to all aircraft with a large wing or horizontal surface.

17. Arrangement according to claim 1, wherein the electric power supply for the fans comes from batteries, fuel cells, electric generators driven by turboshafts or gas turbines.

18. Arrangement according to claim 1, wherein the propulsion is carried out with electric fans, for drones and short range aircraft.

19. Arrangement according to claim 1, wherein the propulsion is carried out with turbofan engines, once it has risen vertically and until the descent, when using a large load or long range.

20. Arrangement according to claim 1, wherein by using a hydraulic installation for actuating the hydraulic motors that drive the tangential and radial fans and blowers.

21. Arrangement according to claim 1, wherein by using a pneumatic installation to activate the pneumatic motors that drive the tangential and radial fans and blowers.

22. Arrangement according to claim 1, wherein by the use of an electrical installation for actuation of the pneumatic motors that drive the tangential and radial fans and blowers.

23. Arrangement according to claim 1, wherein several rows of lift turbines are used both in the wings and in the lateral surface of the fuselage.

24. Arrangement according to claim 1, wherein the fans or turbines are enclosed in cavities on the sides of the wings, horizontal surfaces and the side of the fuselage.

25. Arrangement according to claim 1, wherein by adding deflector fins behind the turbines.

26. Arrangement according to claim 1, c wherein it uses inflatable floats for splashdown.
